(19) United States
(12) Patent Application Publication
(10) Pub. No.: US 2014/0181750 A1
(43) Pub. Date: Jun. 26, 2014

(54) INPUT DEVICE, INPUT OPERATION METHOD, CONTROL PROGRAM, AND ELECTRONIC DEVICE

(71) Applicant: CASIO COMPUTER CO., LTD., Tokyo (JP)

(72) Inventor: Hiroyuki FUJIWARA, Hanno-shi (JP)

(73) Assignee: CASIO COMPUTER CO., LTD., Tokyo (JP)

(21) Appl. No.: 14/105,540

(22) Filed: Dec. 13, 2013

(30) Foreign Application Priority Data
Dec. 20, 2012 (JP) 2012-278079

(51) Int. Cl. G06F 3/0481; G06F 3/0488; G06F 3/0484

(52) U.S. Cl. CPC G06F 3/04817; G06F 3/04842; G06F 3/0488
USPC 715/835

(57) ABSTRACT

An input device of the present invention includes a display section which has a display area where a plurality of icons are two-dimensionally arranged and displayed, and a sensor section which has at least a pair of sensors provided spaced apart from each other in areas which do not overlap with the plurality of icons, and detects operated points operated by an operation performed on the pair of sensors. Based on the operated points detected by the sensor section, one specific icon is selected from among the plurality of icons displayed on the display area. Accordingly, even in a case where many icons are being displayed on a relatively small display area a specific icon can be easily selected.

### CROSS-REFERENCE TO RELATED APPLICATION

This application is based upon and claims the benefit of priority from the prior Japanese Patent Application No. 2012-278079, filed Dec. 20, 2012, the entire contents of which are incorporated herein by reference.

### BACKGROUND OF THE INVENTION

1. Field of the Invention

The present invention relates to an input device, an input operation method, a control program, and an electronic device. Specifically, the present invention relates to an input device, an input operation method, and a control program applicable to an electronic device which has a relatively small housing and for which an input operation is performed by selecting an icon or a menu displayed on a display, and an electronic device including the input device.

2. Description of the Related Art

In recent years various electronic devices having a touch panel type display, such as portable telephones, smartphones (advanced portable telephones), portable music players, and digital cameras, are widely used.

In these electronic devices, a plurality of icons associated with various functions are displayed on the display, and the user performs an input operation by bringing a finger tip, stylus pen, or the like into contact with the surface of the display where the plurality of icons have been displayed and selecting a desired icon, whereby a function associated with that icon is executed.

Also, the display sizes of recent portable electronic devices are increasing for the purpose of improving operability at the time of input operation, increasing the amount of information to be displayed on the display, and improving the viewability of displayed information.

On the other hand, depending on the use purpose, electronic devices are desired whose device bodies including a display have a reduced size.

Examples of electronic devices whose sizes are preferably small include dedicated audio devices, wristwatch type communication terminals having a calling function and a communication function, and exercise support terminals that are worn on a body during an exercise so as to obtain or provide exercise information and the like.

For example, Japanese Patent Application Laid-Open (Kokai) Publication No. 2003-046621 discloses a wristwatch type communication terminal device, in which a portable telephone including a liquid crystal touch panel is worn on an arm of a user by a belt. On the touch panel of the communication terminal device, a plurality of menu button images are displayed and, when the user presses one of the menu button images displayed on the touch panel of the communication terminal device with a dedicated pen or finger (when the user touches a button image), a desired function such as calling or Internet communication is achieved.

In a case where this type of electronic device whose size is preferably small is constantly carried or worn on a body for use, the size of the display and the size of the device including the display in length and width are preferably several centimeters at a maximum, as with the size of a credit card. In the case of a more decreased size, in view of device usability, viewability, etc., three centimeters to four centimeters on every side is thought to be practical, as with the timepiece body of a wristwatch.

On the above-described small sized electronic device, when a number of icons are displayed on the display and the user brings his or her finger tip into contact with a desired icon area to perform an input operation, the perimeter of the contact area is hidden below the finger and therefore whether or not the area of the desired menu icon has been touched is difficult to confirm. Also, in this case, a menu icon that is adjacent to the desired menu icon and used for another function may be selected.

Here, the above-described problem can be avoided if an input operation is performed using a dedicated pen (for example, a stylus pen) as described in Japanese Patent Application Laid-Open (Kokai) Publication No. 2003-046621. However, in this case, the dedicated pen has to be always carried and taken out every time an input operation is required, which significantly impairs the portability and operability of the electronic device. Also, in the case of an electronic device that is used by being worn on the body of a user performing an exercise, an input operation using the dedicated pen is difficult to perform during exercise.

### SUMMARY OF THE INVENTION

The present invention can advantageously provide an input device, an input operation method, and a control program by which, even in a case where a plurality of icons are being displayed on a relatively small sized display, any icon can be accurately and easily selected from these icons with its viewability being ensured, and an electronic device including the input device.

In accordance with one aspect of the present invention, there is provided an input device comprising: a display section which has a display area where a plurality of icons are two-dimensionally arranged and displayed; a first sensor section which has at least a pair of sensors provided spaced apart from each other in areas which do not overlap with the plurality of icons, and detects operated points operated by a first operation performed on the pair of sensors; and an icon selecting section which selects one specific icon from among the plurality of icons displayed on the display area, based on the operated points detected by the first sensor section.

In accordance with another aspect of the present invention, there is provided an electronic device mounted with the above-described input device.

In accordance with another aspect of the present invention, there is provided an input operation method in an input device including a display section where a plurality of icons are displayed and a first sensor section having at least a pair of sensors provided spaced apart from each other in areas which do not overlap with the plurality of icons, comprising a step of two-dimensionally arranging and displaying the plurality of icons on a display area of the display section; a step of causing the first sensor section to detect operated points operated by a first operation performed on the pair of sensors; and a step of selecting one specific icon from among the plurality of icons displayed on the display area, based on the operated points detected by the first sensor section.

In accordance with another aspect of the present invention, there is provided a non-transitory computer-readable storage medium having stored thereon a control program for selecting one of a plurality of icons that is executable by a computer in an input device including a display section where a plurality of icons are displayed and a first sensor section having at least a pair of sensors provided spaced apart from each other in areas which do not overlap with the plurality of icons, wherein the program controls the input device to perform functions comprising: processing for two-dimensionally arranging and displaying the plurality of icons on a display area of the display section; processing for causing the first sensor section to detect operated points operated by a first operation performed on the pair of sensors; and processing for selecting one specific icon from among the plurality of icons displayed on the display area, based on the operated points detected by the first sensor section.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A and FIG. 1B are schematic structural views showing an embodiment of an input device according to the present invention;

FIG. 2 is a block diagram showing a structural example of the input device according to the embodiment;

FIG. 3A and FIG. 3B are schematic views showing structural examples of a touch sensor applied in the input device according to the embodiment;

FIG. 4A and FIG. 4B are schematic views showing examples of an input operation method applied in the input device according to the embodiment;

FIG. 5A and FIG. 5B are schematic views showing a comparative example for describing an operation and effect of the input device and the input operation method according to the embodiment;

FIG. 6A, FIG. 6B and FIG. 6C are first schematic views showing other structural examples of the input device according to the embodiment;

FIG. 7 is a second schematic view showing another structural example of the input device according to the embodiment;

FIG. 8A and FIG. 8B are third schematic views showing other structural examples of the input device according to the embodiment;

FIG. 9A, FIG. 9B, FIG. 9C and FIG. 9D are fourth schematic views showing another structural example of the input device according to the embodiment;

FIG. 10A and FIG. 10B are first schematic views showing other examples of the input operation method applied in the input device according to the embodiment;

FIG. 11A and FIG. 11B are second schematic views showing other examples of the input operation method applied in the input device according to the embodiment;

FIG. 12A and FIG. 12B are third schematic views showing other examples of the input operation method applied in the input device according to the embodiment; and

FIG. 13A and FIG. 13B are schematic structural views showing examples of an electronic device in which the input device according to the present invention has been applied.

### DETAILED DESCRIPTION OF THE PREFERRED EMBODIMENTS

The input device, the input operation method, the control program, and the electronic device according to the present invention are described in detail below with reference to embodiments.

(Input Device)

First, the input device according to the present invention is described.

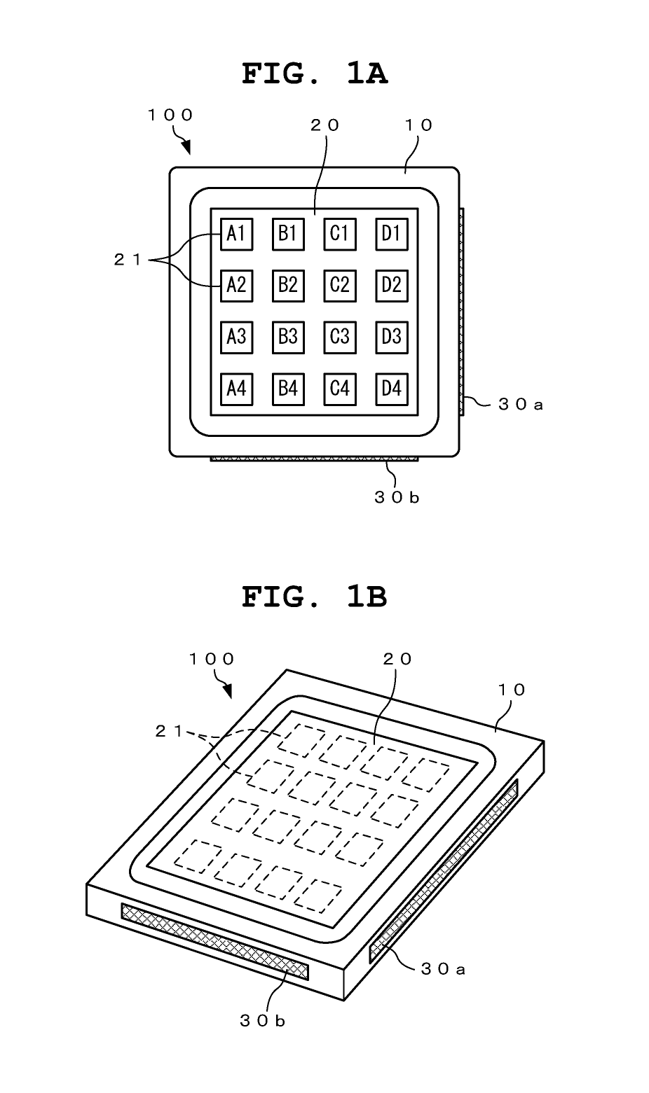

FIG. 1A and FIG. 1B are schematic structural views showing an embodiment of the input device according to the present invention.

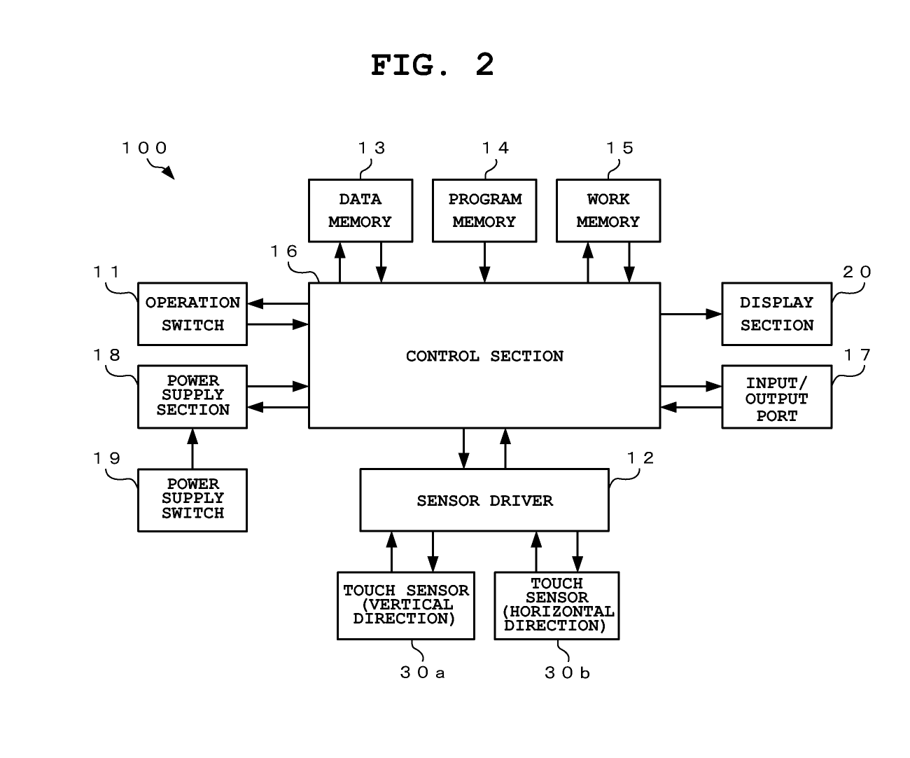

FIG. 2 is a block diagram showing a structural example of the input device according to an embodiment;

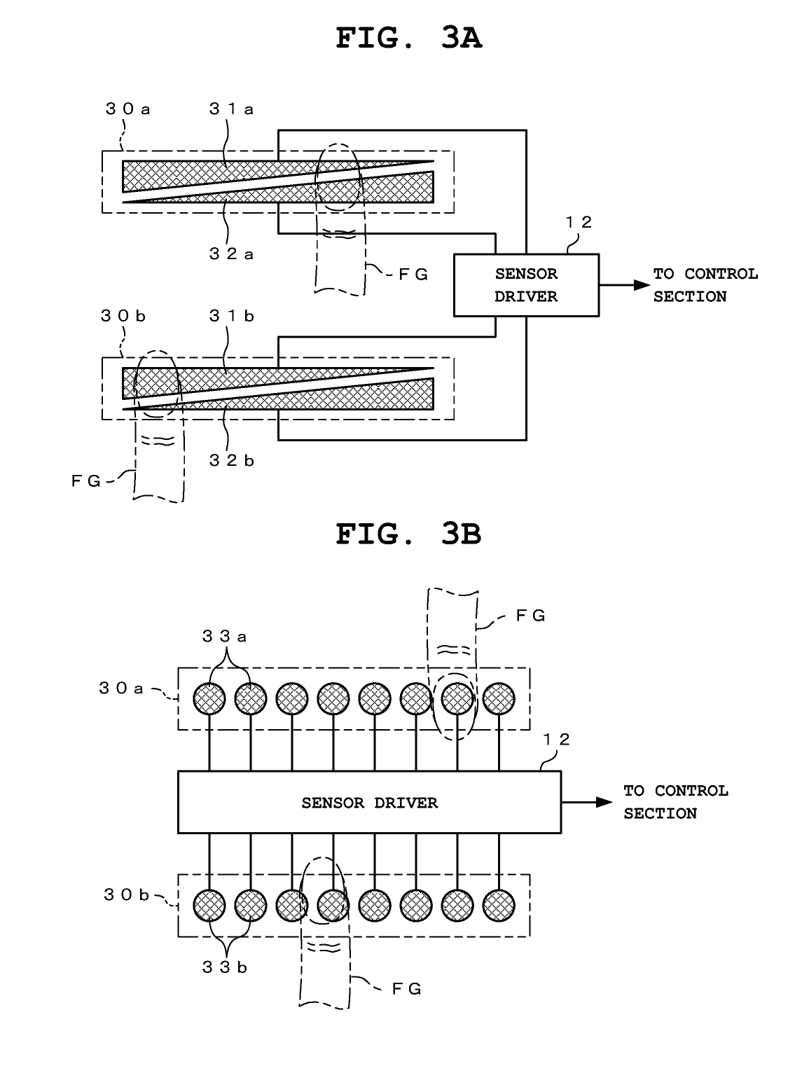

FIG. 3A and FIG. 3B are schematic views showing structural examples of a touch sensor applied in the input device according to the present embodiment.

The input device 100 according to the present embodiment includes, in short, a display section 20 having a rectangular display area, a housing 10 in a rectangular shape provided to surround at least the outer perimeter of the display section 20, and a pair of touch sensors (a first sensor section and a second sensor section) 30a and 30b provided extending to outer circumferential side surfaces of the housing 10 so as to correspond to the arrangement of icons 21 displayed on the display section 20, as depicted in FIG. 1A and FIG. 1B.

Specifically, the input device 100 mainly includes, for example, an operation switch 11, a sensor driver 12, a data storage memory (hereinafter referred to as a “data memory”) 13, a program storage memory (hereinafter referred to as a “program memory”) 14, a work data storage memory (hereinafter referred to as a “work memory”) 15, a control section (an icon selecting section and an icon function executing section) 16, an input/output port 17, a power supply section 18, a power supply switch 19, a display section 20, and the touch sensors 30a and 30b, as depicted in FIG. 2.

The display section 20 has a display panel of, for example, a liquid crystal type allowing color or monochrome display or a light-emitting element type with an organic EL element and the like.

On the display area of the display section 20, at least a plurality of menu icons and the like (hereinafter abbreviated as “icons”) 21 associated with various functions to be executed in the input device 100 are displayed in, for example, a two-dimensional arrangement in a matrix (in the row direction and the column direction), as depicted in FIG. 1A.

Also, in addition to the icons 21, predetermined character information and image information according to various functions are displayed on the display area of the display section 20 when these functions are being performed.

The touch sensors 30a and 30b are provided so as to extend along at least outer circumferential side surfaces in two different directions among the outer circumferential side surfaces of the housing 10 and to be arranged separately from each other, as depicted in FIG. 1A and FIG. 1B. These touch sensors 30a and 30b are, for example, capacitive sensors.

In FIG. 1A, of the outer circumferential side surfaces of the housing 10 with a rectangular outer shape, the touch sensor 30a is provided in the vertical direction on the right side surface, and the touch sensor 30b is provided in the horizontal direction on the lower side surface.

The sensor driver (the first sensor section) 12 outputs, for example, a detection signal indicating each contact point based on a change in capacitance which occurs by a contact of a human body (a finger in the present embodiment) with these touch sensors 30a and 30b. This detection signal is temporarily stored in the data memory 13 and then used for the motion control of an input operation in the control section 16, which will be described further below.

Specifically, the touch sensors 30a and 30b are structured such that paired electrodes 31a and 32a and paired electrodes 31b and 32b having a flat wedge shape are arranged opposite and in reverse to each other, respectively, as depicted in FIG. 3A.

By the human body (a finger FG) coming in contact with both of the paired electrodes 31a and 32a or both of the paired electrodes 31b and 32b, capacitances occurring according to the shape of the electrodes are detected by the sensor driver 12, and the contact point of the human body is detected based on a ratio between the capacitances

The touch sensor 30a formed of the paired electrodes 31a and 32a and the touch sensor 30b formed of the paired electrodes 31b arid 32b are arranged extending along outer circumferential end faces of the housing 10 surrounding the outer perimeter of the display section 20, in two different directions (a vertical direction and a horizontal direction in the present embodiment) having adjacent ends. As a result any arbitrary position or area on the display area of the display section 20 can be indicated based on detection signals indicating contact points in the vertical direction and the horizontal direction.

The touch sensors 30a and 30b applicable to the present embodiment may be structured such that a plurality of electrodes 33a and a plurality of electrodes 33b are respectively arranged in series in a manner to be a predetermined distance apart from each other along the outer circumferential end faces of the housing 10, as depicted in FIG. 3B.

By the human body (the finger FG) coming in contact with the electrode 33a or 33b in the touch sensor 30a or 30b,capacitance occurring at the electrode 33a or 33b is detected by the sensor driver 12. Then, based on the magnitude of capacitance detected at an adjacent electrode 33a or 33b, the contact point of the human body is detected.

As will be described further below, the touch sensors 30aand 30b are to select an arbitrary icon 21 at a point where specified areas (cursor lines) in two different directions displayed corresponding to the contact points of the human body cross from among the plurality of icons 21 displayed and arranged in a matrix on the display area of the display section 20. Therefore, any touch sensors may be adopted as long as they are arranged to extend in two different directions at least along the perimeter of the display section 20.

In the structure depicted in FIG. 1A and FIG. 1B, on the assumption that the input device 100 is operated with (a finger of) the right hand, the touch sensors 30a and 30b are provided on the right and lower side surfaces among the outer circumferential side surfaces of the housing 10. However, the present invention is not limited thereto.

For example, any structure may be adopted as long as the touch sensors are provided on at least two different outer circumferential side surfaces having one end adjacent to that of the other side surface, among the four side surfaces (upper, lower, right and left sides) of the rectangular-shaped housing 10.

Alternatively, a structure may be adopted in which the touch sensors are provided on three or four side surfaces, that is, both of the left and right side surfaces and one or two of the remaining side surfaces, or both of the upper and lower side surfaces and one or two of the remaining side surfaces.

The operation switch 11 has a touch panel arranged on the front surface side (visual field side) of the display screen of the display section 20 or integrally formed on the front surface side, a push button provided on a side part or the front surface of the housing 10, and the like.

The operation switch 11 may have a function equivalent to a function that is achieved by an input operation using the touch sensors 30a and 30b, or may have a unique function different from a function that is achieved by the touch sensors 30a and 30b.

For example, by the user directly touching the display screen of the touch panel, the touch panel can achieve a function equivalent to the function of the touch sensors 30a and 30b.

In a case where the touch panel has a small sized display screen as the input device 100 of the present embodiment, it can be effectively used for an input operation when relatively large icons are being displayed.

The push button can be effectively used by having a specific function that is difficult to achieve by the touch sensors 30a and 30b and the touch panel, such as the function of a power supply switch.

Note that, in a configuration where all functions of the input device 100 can be achieved by the touch sensors 30a and 30b described in the present embodiment, the operation switch 11 including a touch panel, a push button, etc., may be omitted (excluded).

The data memory 13 has a non-volatile memory such as a flash memory, in which data associated with contact points detected by the touch sensors 30a and 30b and the sensor driver 12 is stored.

The program memory 14 includes a ROM (Read Only Memory), and has stored therein a program for achieving a predetermined function in each component (such as the display section 20 and the sensor driver 12) of the input device 100 and a program for achieving motion control associated with an input operation, which will be described further below.

The work memory 15 includes a RAM (Random Access Memory), and temporarily stores data that is generated or referred to by executing the above-described programs.

The non-volatile memory portion forming the data memory 13 may be structured to include a removable storage medium such as a memory card and be removable from the input device 100.

The control section 16, which is a CPU (Central Processing Unit) or a MPU (Micro-Processor Unit), performs processing by following a program stored in the program memory 14, and whereby the control section 16 controls an operation of displaying icons and other information on the display section 20, an operation of detecting the position of a finger of the user touching the touch sensors 30a and 30b, an operation of selecting an arbitrary icon from the plurality of icons 21 arranged in a matrix and displayed on the display section 20 and executing a predetermined function associated with this icon 21, etc.

The above-described program may be previously incorporated in the control section 16.

The input/output port 17 has a connecting function for transmitting and receiving data to and from a device provided outside the input device 100 and other purposes.

Specifically, by being connected to a personal computer or the like, the input/output port 17 performs backup of data stored in the data memory 13, or data transmission for updating a function to be achieved by a program.

By the operation of the power supply switch 19, or based on an instruction from the control section 16, the power supply section 18 controls supply or shutoff of driving electric power to each component of the input device 100.

The power supply section 18 has a primary battery such as a commercially available coin shaped battery or button shaped battery or a secondary battery such as a lithium-ion battery or a Nickel Metal Hydride battery.

Note that a power supply by energy harvest technology for generating electricity by energy such as vibrations, light, heat, or electro-magnetic waves may be applied herein.

Also, the above-described push button provided as the operation switch 11 may be used as the power supply switch 19.

(Input Operation Method)

Next, the input operation method in the input device according to the present embodiment is described.

Here, a case where the input device is operated with the right hand is described.

Note that a series of operation control for the input operation method described below is achieved by executing a predetermined program at the control section 16.

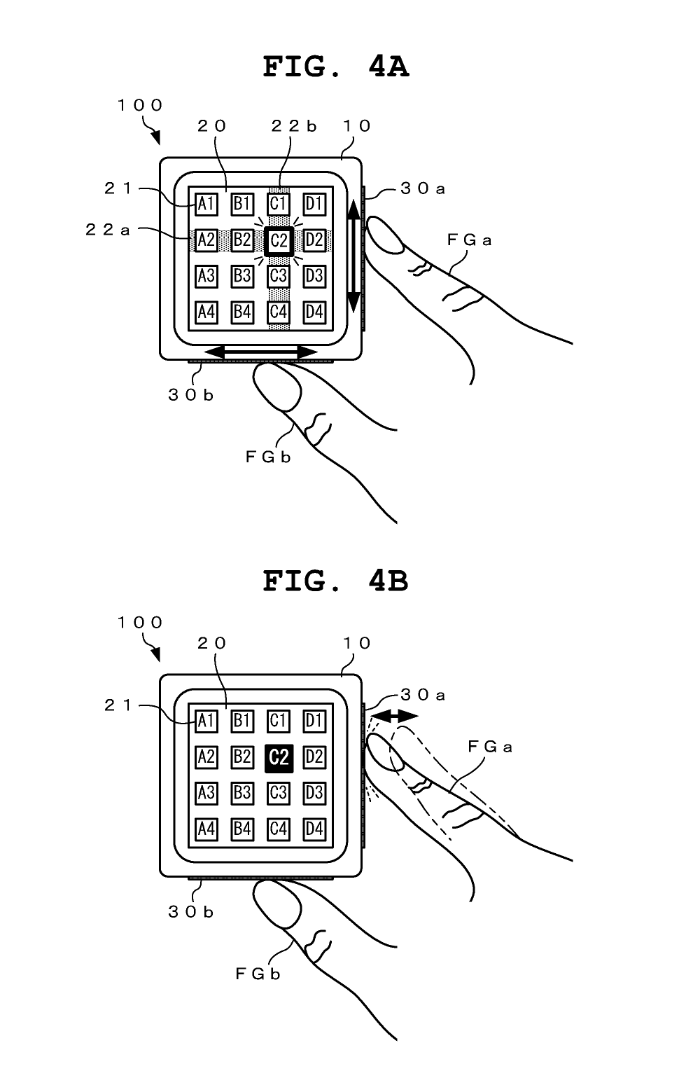

FIG. 4A and FIG. 4B are schematic views showing an example of the input operation method applied in the input device according to the present embodiment.

In the input operation method of the input device according to the present embodiment, first, the user uses two fingers of the right hand to select an arbitrary icon 21 with the plurality of icons 21 being arranged in a matrix and displayed on the display section 20 of the input device 100.

Specifically, when the user brings, for example, his or her index finger FGa of the right hand into contact with the touch sensor 30a provided on the right side surface of the input device 100 in the vertical direction in the drawing as depicted in FIG. 4A, the sensor driver 12 detects the contact point of the index finger FGa on the touch sensor 30a (first operation).

Subsequently, the control section 16 causes a cursor line 22a in the horizontal direction (the row direction of the matrix of the icons 21; the leftward and rightward direction in the drawing) which is indicating a specified area to be displayed corresponding to this contact point on the display area

Then, the user slides the index finger FGa in the extending direction of the touch sensor 30a (the upward and downward direction in the drawing; refer to a double-headed arrow in the drawing) with it being in contact with the touch sensor 30a, and the control section 16 causes the cursor line 22a to be moved uninterruptedly or in stages in the upward or downward direction on the display area, corresponding to the change of the contact point.

Similarly, when the user brings his or her thumb FGb of the right hand into contact with the touch sensor 30b provided on the lower side surface of the input device 100 in the horizontal direction in the drawing, the sensor driver 12 detects the contact point of the thumb FGb on the touch sensor 30b (first operation).

Subsequently, the control section 16 causes a cursor line 22b in the vertical direction (the column direction of the matrix of the icons 21; the upward and downward direction in the drawing) which is indicating a specified area to be displayed corresponding to this contact point on the display area.

Then, the user slides the thumb FGb in the extending direction of the touch sensor 30b (the leftward and rightward direction in the drawing; refer to a double-headed arrow in the drawing) with it being in contact with the touch sensor 30b, and the control section 16 causes the cursor line 22b to be moved uninterruptedly or in stages in the leftward and rightward direction on the display area, corresponding to the change of the contact point.

Then, the control section 16 sets, in a selected state, an icon (icon “C2” in FIG. 4A) 21 at a point at the intersection of the cursor lines 22a and 22b displayed corresponding to the contact points of the fingers (the index finger FGa and the thumb FGb) on the touch sensors 30a and 30b provided along the two different directions.

The icon 21 in the selected state is highlighted with, for example, a color (including color reversal), a luminance, a display size, an animation (specific moving display), and the like that are highly visible compared with those of the other icons, as depicted in FIG. 4A.

Note that, in a structure where the input device 100 includes reporting means, such as a loudspeaker or a vibrator, as an output interface, a predetermined sound or vibration may be generated every time an icon 21 is set in a selected state, whereby the selected state is reliably reported to the user.

Here, the cursor lines 22a and 22b displayed on the display area by the fingers touching the touch sensors 30a and 30b may be displayed in stages for each row or each column, corresponding to the arrangement of the icons 21 in a matrix, or may be moved uninterruptedly on the display area, corresponding to the changes of the contact points of the fingers.

These cursor lines 22a and 22b are preferably displayed using a highly visible color (including color reversal), a highly visible illuminance, or the like compared with those of surrounding images.

Also, a configuration may be adopted in which, in place of or in addition to the display of the cursor lines 22a and 22b, icons (icons “A2” to “D2” and “C1” to “C4” in FIG. 4A) 21 arranged in an area corresponding to the contact points of the fingers on the touch sensors 30a and 30b are highlighted.

Here, in a case where the pad of a finger is brought into contact with the touch sensor 30a or 30b, the contact point detected by the sensor driver 12 may possibly be considered as a relatively wide area. Thus, when the contact point (contact area) of a finger includes a plurality of rows and columns of the icons 21 arranged in a matrix, for example, the control section 16 performs control by determining the center portion of the contact area as a contact point, setting the width of the cursor line 22a or 22b to be a relatively narrow constant value not allowing a plurality of icons 21 to be selected, and displaying the cursor line 22a or 22b corresponding to the position.

As a result, from among the plurality of icons 21 arranged in a matrix and displayed on the display section 20, an arbitrary icon 21 can be unfailingly selected.

Alternatively, a configuration may be adopted in which the control section 16 determines, as a contact point, an area on the touch sensor 30a or 30b where a finger has first touched, sets the width of the cursor line 22a or 22b to be a relatively narrow constant value not allowing a plurality of icons 21 to be selected, displays the cursor line 22a or 22b on this contact point, and moves the positions of the cursor line 22a or 22b according to the movement of the contact point of the finger.

Next, with the arbitrary icon 21 in the display area being set in the selected state, the user performs a specific operation to execute a function associated with the icon 21 in the selected state.

Specifically, for example, the user performs an operation (a so-called tap operation) of moving one (the index finger FGa in the drawing) of the fingers (the index finger FGa and the thumb FGb) touching the touch sensors 30a and 30b apart from the relevant one of the touch sensors 30a and 30b for a short period of time and then bringing the finger into contact again (second operation), as depicted in FIG. 4B.

As a result, the control section 16 executes a predetermine function associated with the icon 21 (“C2”) set in the selected state.

Note that the operation (second operation) for performing a function associated with an icon 21 set in a selected state is not limited to the above-described method in which a tap operation is performed with one of fingers touching the touch sensors 30a and 30b.

For example, a method may be applied in which a tap operation is performed with both fingers simultaneously or sequentially.

Also, for example, a configuration may be adopted in which, by a tap operation being successively performed twice (a so-called double tap operation), the control section 16 causes a function associated with a selected icon to be reliably executed. In this case, in the above-described method where a predetermined function is performed by a one tap operation, the possibility of an icon different from the icon of a desired function being selected by an inexperienced user, which leads to an erroneous operation, can be reduced.

(Verification of Operations and Effects)

Next, operations and effects of the input device and the input operation method according to the present embodiment are described in detail by presenting a comparative example.

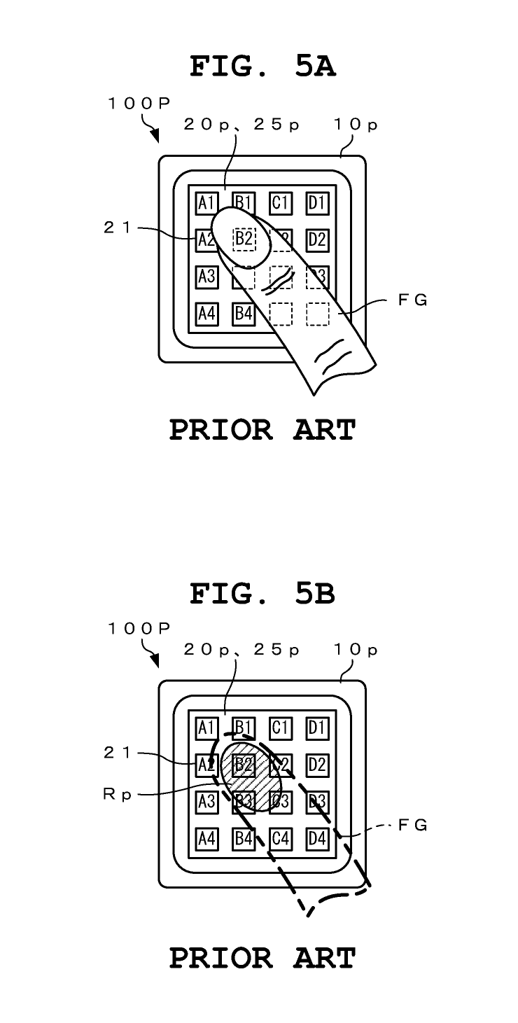

FIG. 5A and FIG. 5B are schematic views showing a comparative example for describing the operation and effect of the input device and the input operation method according to the present embodiment.

Here, components equivalent to those of the above-described embodiment are provided with the same reference numerals.

First, an input device and an input operation method in the comparative example are described.

Here, an input device 100P in the comparative example has a display section 20p, a touch panel 25p arranged on the front surface side (visual field side) of the display section 20p or integrally formed with the display section 20p, and a housing 10p provided with the display section 20p and the touch panel 25p on one surface side (front side in the drawing).

That is, this input device 100P has the seine structure as the input device 100 of the present embodiment (refer to FIG. 1) except that it does not have the touch sensors 30a and 30b on side surfaces of the housing 10 and therefore the selection of an arbitrary icon 21 is made through the touch panel 25p provided on the front surface of the display section 20p.

Here, a case is examined in which, in the comparative example where many icons 21 are arranged on the display section 20p (for example, a 4×4 arrangement in length and width) as depicted in FIG. 5A, an arbitrary icon 21 is selected from among the icons 21 to perform a desired function.

In this case, when the user tries to perform an input operation by touching an area where an arbitrary icon 21 (an icon “B2” in the drawing) is being displayed with the finger FG, the area including the icon 21 (the icon “B2”) is hidden below the finger FG, and therefore whether the area of the desired icon 21 has been touched cannot be confirmed.

Also, since the area Rp touched with the finger FG cannot be confirmed as depicted in FIG. 5B, if the contact area Rp of the finger FG is wider than the size of the icon 21 or the arrangement space, not only the icon 21 desired to be selected but also another adjacent icon 21 may be selected, or not the icon 21 desired to be selected but another adjacent icon 21 may be selected, whereby the desired function is not executed.

As a method for avoiding this trouble, there is a method in which an arbitrary icon 21 is selected not by using the finger FG but by using a stylus pen or the like.

However, in this case, the stylus pen or the like has to be always carried and taken out every time an input operation is required to be performed, which significantly impairs the portability and operability of the electronic device.

In a case where this type of input device has been applied in an exercise support terminal or the like that is used by being worn on the body of a user performing an exercise, the accurate selection of a desired icon 21 by a stylus pen or the like is difficult to make during an exercise.

In contrast, in the input device and the input operation method according to the present embodiment, as depicted in FIGS. 4A and 4B, the user brings his or her different fingers into contact with the separate touch sensors 30a and 30b provided on outer circumferential side surfaces of the input device in two different directions, and specifies a row and a column of the plurality of icons 21 arranged in a matrix, whereby an icon 21 at a point at the intersection of the specified areas (the cursor lines 22a and 22b) in the row direction and the column direction is set in a selected state.

In addition, in the series of input operations in this method, the user further performs a tap operation on each of the touch sensors 30a and 30b, whereby a function associated with the icon 21 in the selected state is executed.

That is, in the present embodiment, by operating the touch sensors 30a and 30b provided on outer circumferential side surfaces of the housing 10 of the input device 100 including the display section 20 of a relatively small size, the user can select an arbitrary icon 21 from among the icons 21 arranged in a matrix on the display area. As a result of this configuration, the user's finger tip is prevented from being positioned on the front surface of the display section 20 and therefore does not interfere with the user's view.

Thus, according to the present invention, it is possible to unfailingly select only an arbitrary icon and perform a desired function, with its viewability being ensured.

In addition, according to the present invention, a stylus pen or the like is not required to be always carried for input operation. Accordingly, the portability and operability of an electronic device including the input device 100 according to the present embodiment are not impaired.

Moreover, even when the input device 100 according to the present embodiment is applied. In an exercise support terminal or the like that is used by being worn on the body of a user performing an exercise, an arbitrary icon can be accurately selected and a desired function can be relatively easily performed during an exercise such as running.

(Other Examples of Input Device)

Next, other examples (modification examples) of the structure of the input device according to the embodiment are described.

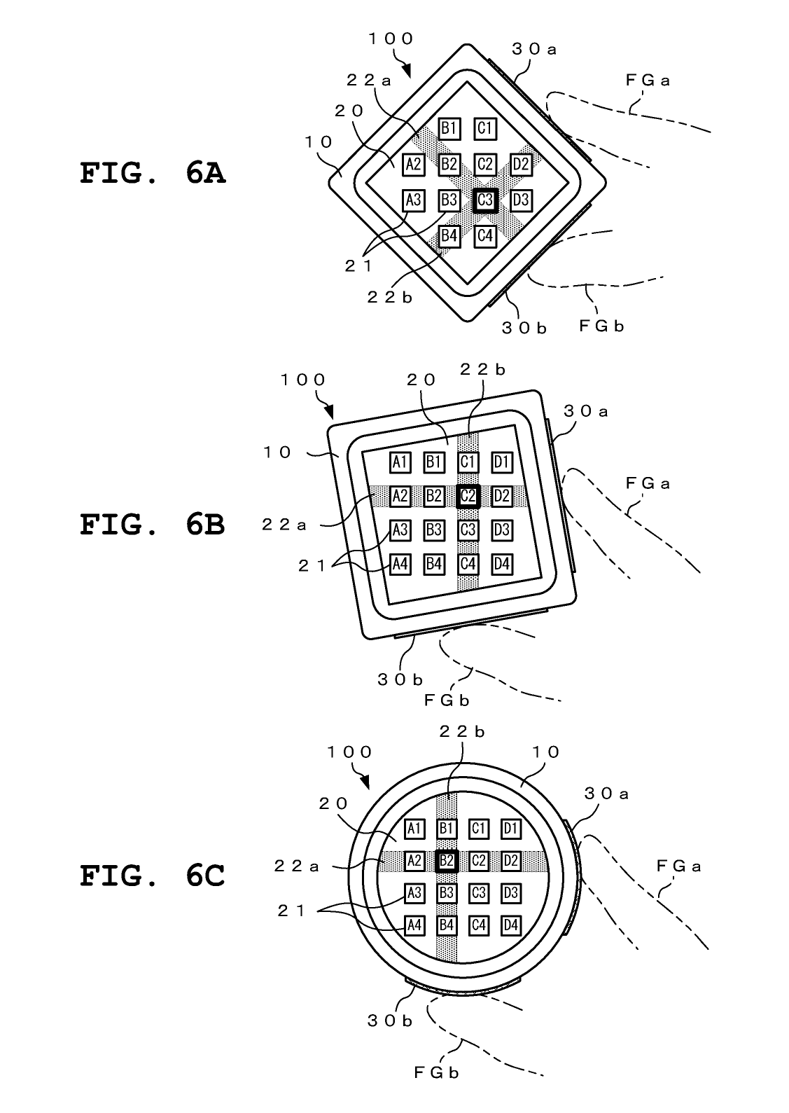

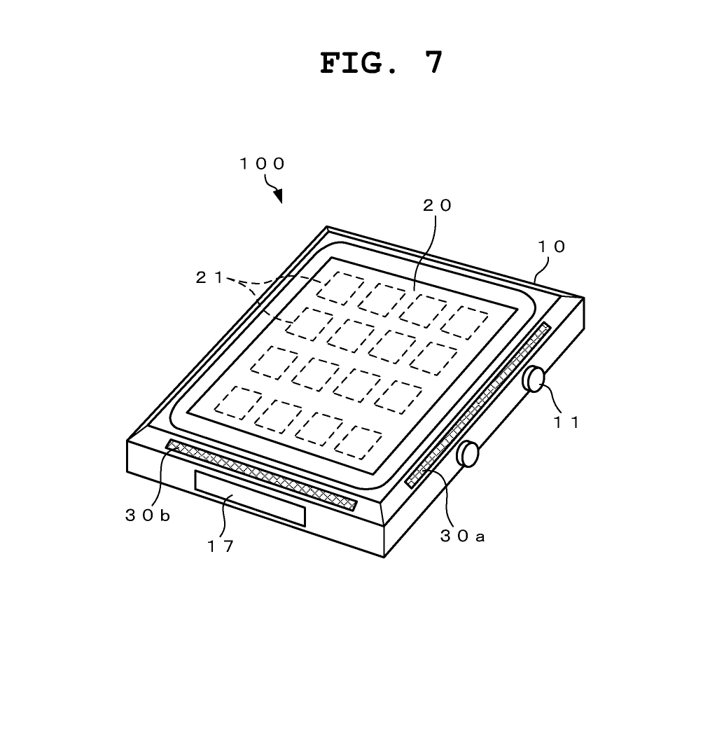

FIG. 6A, FIG. 6B, FIG. 6C and FIG. 7 are schematic views showing other examples of the structure of the input device according to the present embodiment.

Note that descriptions of components equivalent to those of the above-described embodiment are simplified.

In the above-described embodiment, the input device 100 is described in which the plurality of icons 21 are arranged in a matrix in the row direction and the column direction) on the display area of the display section 20 in the housing 10 having a rectangular outer shape so as to coincide with the extending directions of the outer circumferential side surfaces of the housing 10, and the touch sensors 30a and 30b are provided extending along the outer circumferential side surfaces of the housing 10.

However, the present invention is not limited thereto.

Various modification examples, such as first and second modification examples described below, may be applied.

### FIRST MODIFICATION EXAMPLE

The first modification example of the input device according to the present embodiment has the same structure as the input device 100 of the above-described embodiment except that the row direction and the column direction of the plurality of icons 21 arranged in a matrix do not coincide with the extending direction of the outer circumferential side surfaces of the rectangular-shaped housing 10, as depicted in FIG. 6A and FIG. 6B.

That is the first modification example is structured such that the extending directions (two directions orthogonal to each other) of the touch sensors 30a and 30b provided on outer circumferential side surfaces of the housing 10 do not coincide with the arrangement direction of the icons 21.

The input device depicted in FIG. 6A has a structure in which the extending direction of the outer circumferential side surfaces of the housing 10 is tilted by 45 degrees with respect to the row direction and the column direction of the plurality of icons 21 arranged in a matrix.

The input device depicted in FIG. 6B has a structure in which the extending direction of the outer circumferential side surfaces of the housing 10 is tilted by an arbitrary angle (for example, 15 degrees) with respect to the row direction and the column direction of the plurality of icons 21 arranged in a matrix.

Regarding the above-structured input device 100 in FIG. 6A, for example, when the user brings the index finger FGa into contact with the touch sensor 30a and brings the thumb FGb into contact with the touch sensor 30b, the cursor lines 22a and 22b corresponding to the respective contact points are displayed on the display area in directions coinciding with the extending directions of the outer circumferential side surfaces of the housing 10 (or in directions orthogonal to the respective extending directions of the touch sensors 30a and 30b).

In this case as well, the cursor lines 22a and 22b are displayed along two different directions, corresponding to the touch sensors 30a and 30b provided in two different directions. Accordingly, an icon (in FIG. 6A, icon “C3”) 21 at the point of intersection of these cursor lines 22a and 22b is set in a selected state.

In FIG. 6B, for example, when the user brings the index finger FGa into contact with the touch sensor 30a and brings the thumb FGb into contact with the touch sensor 30b, the cursor lines 22a and 22b corresponding to the respective contact points are displayed on the display area in directions coinciding with the row direction and the column direction of the arrangement of the icons 21 in a matrix.

That is, the cursor lines 22a and 22b are displayed in directions not coinciding with the extending directions of the outer circumferential side surfaces of the housing 10 (or in directions not orthogonal to the extending directions of the touch sensors 30a and 30b).

In this case as well, the cursor lines 22a and 22b are displayed along two different directions, corresponding to the touch sensors 30a and 30b provided in two different directions. Accordingly, an icon (in FIG. 6B, icon “C2”) 21 at the point of intersection of these cursor lines 22a and 22b is set in a selected state.

In this modification example as well, a finger tip is not positioned on the front surface of the display section 20 at the time of the selection of an icon 21. Therefore, an arbitrary icon 21 can be accurately selected to perform a desired function, with its vie ability being ensured.

Also, in the present modification example, the extending directions of the outer circumferential side surfaces of the housing 10 are tilted by an arbitrary angle with respect to the row direction and the column direction of the plurality of icons 21 arranged in a matrix. Therefore, an operation of selecting an arbitrary icon 21 by bringing two fingers (the index finger FGa and the thumb FGb) into contact with the touch sensors 30a and 30b can be easily performed in conformity with the human skeletal structure and the movement of joints. As a result, the operability of the input device 100 is improved without significantly changing the structure thereof.

### SECOND MODIFICATION EXAMPLE

The second modification example of the input device according to the present embodiment has a structure in which the plurality of icons 21 are arranged in a matrix (in the row direction and the column direction) on the display area of the display section 20 provided in the housing 10 having a circular outer shape, and the touch sensors 30a and 30b are provided extending along the outer circumferential side surface of the housing 10, corresponding to the row direction and the column direction of the plurality of icons 21 arranged in a matrix, as depicted in FIG. 6C.

That is, in the drawing, the touch sensors 30a and 30b are provided along the right and lower outer circumferential side surfaces of the housing 10 which has a shape equivalent to that of the frame of a circular timepiece body for a general wristwatch.

Regarding the above-structured input device 100, for example, when the user brings the index finger FGa into contact with the touch sensor 30a and brings the thumb FGb into contact with the touch sensor 30b, the cursor lines 22a and 22b corresponding to the respective contact points are displayed on the display area in the row direction and the column direction of the plurality of icons 21 arranged in a matrix, as depicted in FIG. 6C.

In this case as well, the cursor lines 22a and 22b are displayed along two different directions, corresponding to the touch sensors 30a and 30b provided in two different directions (two directions substantially orthogonal to each other). Accordingly, an icon (in FIG. 6C, icon “B2”) 21 at the point of intersection of these cursor lines 22a and 22b is set in a selected state.

In this modification example as well, a finger tip is not positioned on the front surface of the display section 20 at the time of the selection of an icon 21. Therefore, an arbitrary icon 21 can be accurately selected to perform a desired function, with its viewability being ensured.

Also, in the present modification example, for the plurality of icons 21 arranged in a matrix, the touch sensors 30a and 30b are provided extending along the outer circumferential side surface of the housing 10 having a circular shape. Therefore, even though the housing 10 has a circular shape that is applied to a general wristwatch, an operation of selecting an arbitrary icon 21 by bringing two fingers (the index finger FGa and the thumb FGb) into contact with the touch sensors 30a and 30b can be easily performed in conformity with the human skeletal structure and the movement of joints, whereby the operability is improved.

In the first and second modification examples, the extending directions of the touch sensors 30a and 30b provided on outer circumferential side surfaces of the housing 10 are two directions orthogonal to each other (the vertical direction and the horizontal direction). However, the present invention is not limited thereto.

That is, in the present invention, a configuration may be adopted in which the positional relation (the extending directions) of the touch sensors 30a and 30b is set along two arbitrary directions other than those orthogonal to each other, and an icon 21 at the point of intersection of the cursor lines 22a and 22b displayed along two different directions other than the row direction and the column direction of the icon 21 is set in a selected state.

### THIRD MODIFICATION EXAMPLE

In the above-described embodiment the input device 100 is described in which only the touch sensors 30a and 30b are provided on outer circumferential side surfaces of the housing 10 having a rectangular outer shape.

However, the present invention is not limited thereto.

As will be described below, the present invention may be applied in the housing 10 having the operation switch 11, the input/output port 17, and the like provided on outer circumferential side surfaces thereof.

The third modification example of the input device according to the embodiment has the same structure as the input device 100 of the above-described embodiment except that a push button serving as the operation switch 11 and a connector applied as the input/output port 17 are provided on outer circumferential side surfaces of the housing 10 in two different directions, and the touch sensors 30a and 30b are provided on tilted surfaces between the outer circumferential side surfaces and a flat surface including the display screen of the display section 20, as depicted in FIG. 7.

In this modification example as well, a finger tip is not positioned on the front surface of the display section 20 at the time of the selection of an icon 21. Therefore, an arbitrary icon 21 can be accurately selected to perform a desired function, with its viewability being ensured.

In addition, according to the present modification example, the arrangement of the existing operation switch 11 and input/output port 17 and the like is not required to be changed. Therefore, a cost increase associated with design change or change in manufacture processing can be suppressed to minimum.

### FOURTH MODIFICATION EXAMPLE

In each of the above-described embodiments, the touch sensors 30a and 30b are provide on outer circumferential side surfaces of the housing 10 of the input device 100.

However, the present invention is not limited thereto.

That is, in the present invention, any structure can be adopted as long as an arbitrary icon 21 can be selected using the touch sensors 30a and 30b provided extending along two different directions, from among the plurality of icons 21 arranged in a matrix on the display area.

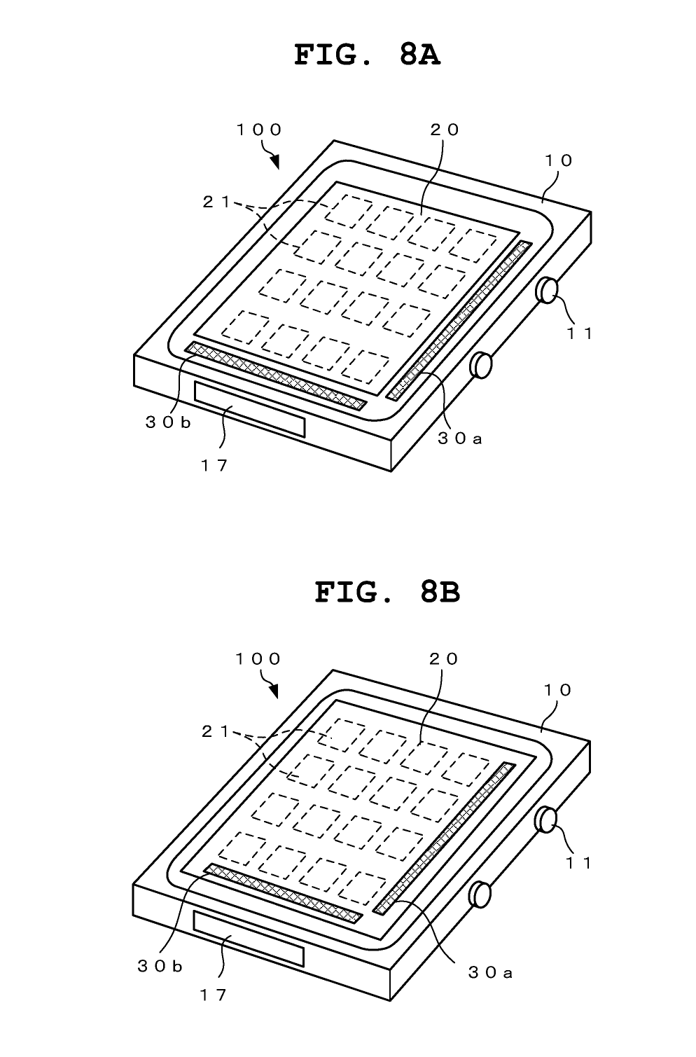

A fourth modification example of the input device according to the embodiment has, for example, a structure in which the touch sensors 30a and 30b are provided on the same plane as the display screen of the display section 20 and positioned in an outer circumferential area (a so-called frame area) around the display area, as depicted in FIG. 8A.

Alternatively, the fourth modification example may have a structure in which the touch sensors 30a and 30b are provided outside the plurality of icons 21 arranged in a matrix on the display area, and positioned in an area near the outer circumferential area of the display area, as depicted in FIG. 8B.

In this modification example as well, a finger tip is not positioned on the front surface of the display section 20 at the time of the selection of an icon 21. Therefore, an arbitrary icon 21 can be accurately selected to perform a desired function, with its viewability being ensured.

In addition, according to the present modification example, the arrangement of the existing operation switch 11 and the input/output port 17 and the like is not required to be changed, as with the third modification example. Therefore, a cost increase associated with design change or change in manufacture processing can be suppressed to minimum.

### FIFTH MODIFICATION EXAMPLE

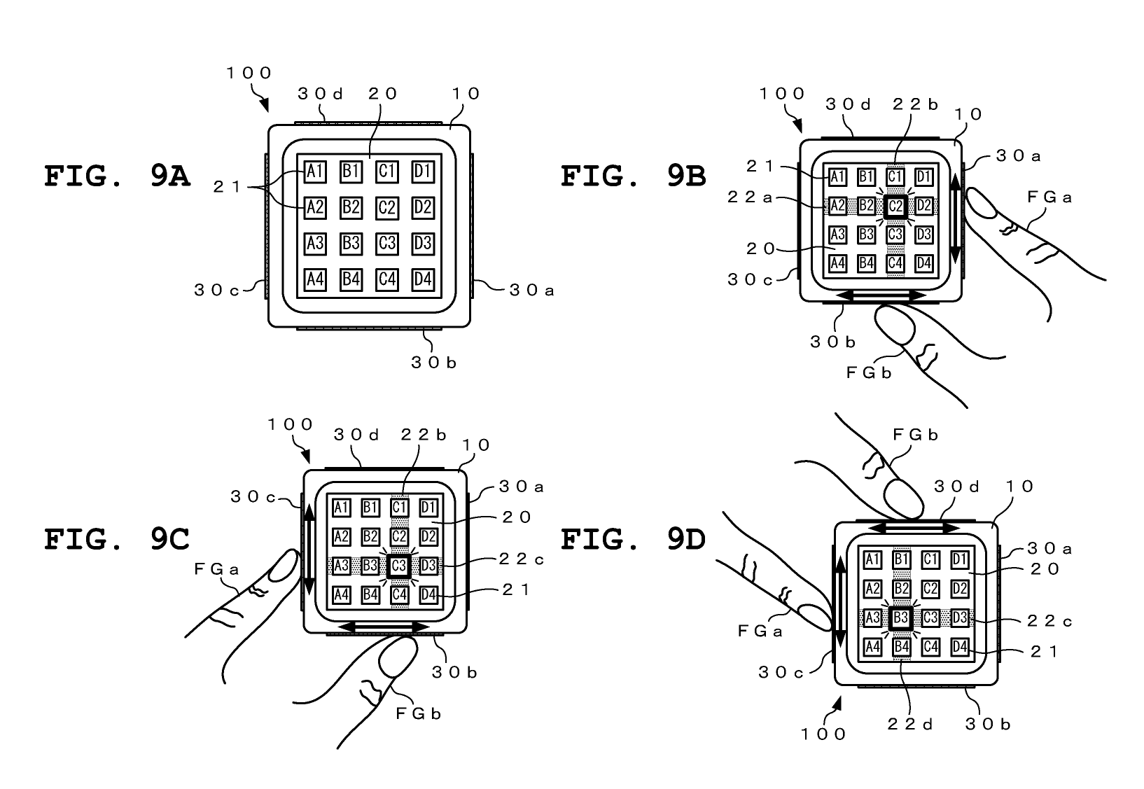

A fifth modification example of the input device according to the embodiment has the same structure as the input device 100 of the above-described embodiment except that touch sensors 30a, 30b, 30c, and 30d are provided extending along four sides corresponding to the outer circumferential side surfaces of the housing 10, as depicted in FIG. 9A.

That is, in the above-described embodiment, the touch sensors 30a and 30b are provided on the right and lower side surfaces among the outer circumferential side surfaces of the housing 10, and the touch sensors 30a and 30b are operated with the fingers of the right hand.

In contrast, in the fifth embodiment, the touch sensors 30a, 30b, 30c, and 30d are provided along four sides corresponding to the outer circumferential side surfaces of the housing 10.

Here, the touch sensors 30a and 30c are provided facing each other across the display area, which serve as a first touch sensor and a third touch sensor of the present invention.

The touch sensors 30b and 30d are provided facing each other across the display area, which serve as a second touch sensor and a fourth touch sensor of the present invention.

In this case, by using touch sensors provided on adjacent two sides where a contact of the human body has been detected, that is, by using the touch sensors 30a and 30b, the touch sensors 30b and 30c, the touch sensors 30c and 30d, or the touch sensors 30d and 30a to perform operation in a manner similar to that of the above-described embodiment, the operation can be performed with fingers of the right or left hand.

In addition, the operation can be performed similarly from the other side of the display area.

Here, FIG. 9B depicts the case in which the touch sensors 30a and 30b are used to perform operation with two fingers of the right hand.

FIG. 9C depicts the case in which the touch sensors 30b and 30c are used to perform operation with two fingers of the left hand.

FIG. 9D depicts the case in which the touch sensors 30c and 30d are used to perform operation from the other side of the display area, which is opposite to the case of FIG. 9B.

In this modification example as well, a finger tip is not positioned on the front surface of the display section 20 at the time of the selection of an icon 21. Therefore, an arbitrary icon 21 can be accurately selected to perform a desired function, with its viewability being ensured.

According to the present modification example, operation can be performed with either of the right or left hand. Therefore, the same input device 100 can be used similarly by both of right-handed and left-handed persons.

In addition, the input device 100 can be similarly used by a person facing the user across the input device 100, which improves the operability and the convenience of the input device 100.

(Another Example of Input Operation Method)

Next, another example (modification example) of the Input operation method according to the above-described embodiment is described.

In the above-described embodiment, the input operation method is described in which two fingers, such as the index finger FGa and the thumb FGb, are used to operate the touch sensors 30a and 30b provided in two different directions so as to set an arbitrary icon 21 in a selected state, and then a tap operation is performed on the touch sensors 30a and 30b with one of the fingers to execute a function associated with the icon 21.

However, the present invention is not limited thereto. For example, various modification examples such as those described below may be applied,

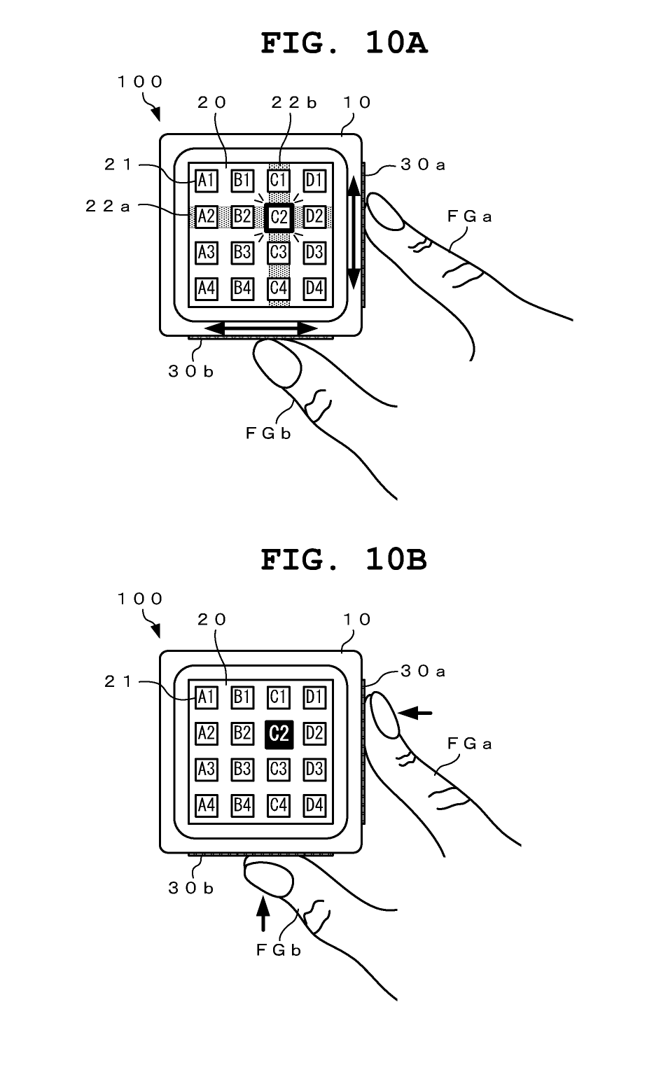

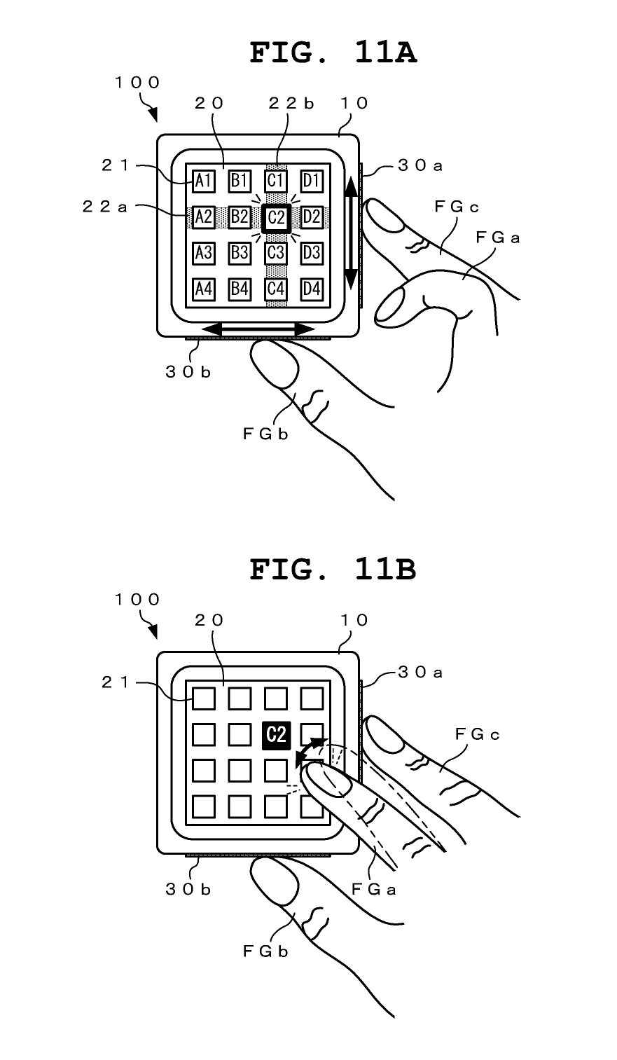

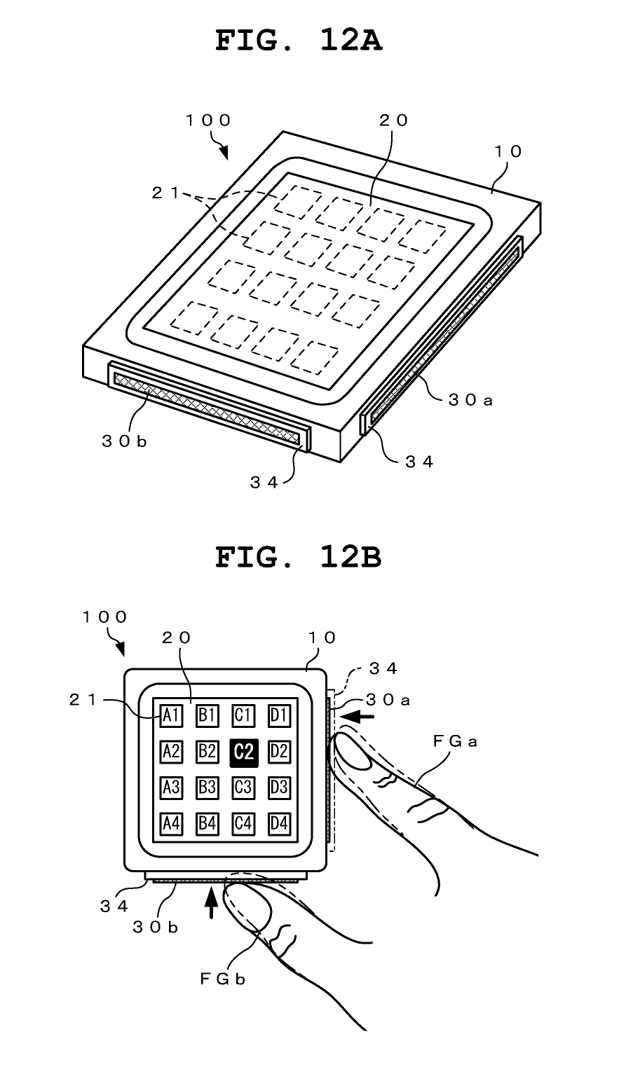

FIG. 10A, FIG. 10B, FIG. 11A, FIG. 11B, FIG. 12A and FIG. 12B are schematic diagrams showing other examples of the input operation method applied in the input device according to the present embodiment.

Note that descriptions of components and input operations equivalent to those of the above-described embodiment are simplified.

### FIRST MODIFICATION EXAMPLE

As with the above-described embodiment, in a first modification example of the input operation method according to the present embodiment, first, the user operates the touch sensors 30a and 30b provided in two different directions with two fingers, such as the index finger FGa and the thumb FGb, and thereby sets an arbitrary icon 21 (in FIG. 10A, icon “C2”) in a selected state, as depicted in FIG. 10A.

Next, the user strongly presses the respective fingers touching the touch sensors 30a and 30b onto these touch sensors 30a and 30b simultaneously or sequentially, as depicted in FIG. 11B. As a result, the contacting faces between the touch sensors 30a and 30b and the respective fingers are deformed such that their areas are widened. The change of capacitance occurred herein along with the change of each contacting area is detected by the sensor driver 12, and a desired function associated with the icon 21 in the selected state is executed.

In this modification example as well, a finger tip is not positioned on the front surface of the display section 20 at the time of the selection of an icon 21. Therefore, an arbitrary icon 21 can be accurately selected to perform a desired function, with its viewability being ensured.

According to this modification example, the operation of executing a desired function associated with an icon 21 in a selected state can be easily achieved by using the degree of pressing of fingers onto the touch sensors 30a and 30b (contact area), without changing the structure of the input device 100.

### SECOND MODIFICATION EXAMPLE

In a second modification example of the input operation method according to the present embodiment, a touch panel (a second sensor section) serving as the operation switch 11 is provided on the front surface side of the display section 20 in the input device 100 of the above-described embodiment.

The user brings two fingers other than the index finger FGa (a middle finger FGc and the thumb FGb in the drawing) into contact with the touch sensors 30a and 30b of the above-structured input device 100, respectively, and thereby sets an arbitrary icon 21 of the plurality of icons 21 arranged on the display section 20 in a selected state, as depicted in FIG. 11A.

Next, the user performs a tap operation on an arbitrary area on the touch panel provided on the front surface of the display section 20 by using a finger (the index finger FGa in the drawing) between the two fingers used to select the icon 21 (the middle finger FGc and the thumb FGb), as depicted in FIG. 11B. As a result, a desired function associated with the icon 21 in the selected state is executed.

In this modification example as well, a finger tip is not positioned on the front surface of the display section 20 at the time of the selection of an icon 21. Therefore, an arbitrary icon 21 can be accurately selected to perform a desired function, with its viewability being ensured.

According to the present modification example, operation of selecting an arbitrary icon 21 by bringing two fingers (the middle finger FGc and the thumb FGb) into contact with the touch sensors 30a and 30b and an operation of executing a desired function associated with the icon 21 in the selected state by a tap operation with a finger the index finger FGa) between the two fingers can be easily performed in conformity with the human skeletal structure and the movement of joints. As a result, the operability of the input device 100 can be improved without significantly changing the structure thereof.

### THIRD MODIFICATION EXAMPLE

In a third modification example of the input operation method according to the present embodiment, tactile switches (second sensor section) 34, which are push button type operation switches, are provided projecting from outer circumferential side surfaces of the housing 10 of the input device 100 of the above-described embodiment in two different directions, and the touch sensors 30a and 30b are provided on the projection surfaces of the tactile switches 34, as depicted in FIG. 12A.

The user brings two fingers (the index finger FGa and the thumb FGb) into contact with the touch sensors 30a and 30b of the above-structured input device 100, respectively, and thereby sets an arbitrary icon 21 of the plurality of icons 21 arranged on the display section 20 in a selected state, as in the case of the above-described embodiment.

Next, with the respective fingers touching the touch sensors 30a and 30b, the user presses the tactile switches 34 with both fingers or one of the fingers simultaneously or sequentially, as depicted in FIG. 12B. As a result, a desired function associated with the icon 21 in the selected state is executed.

In this modification example as well, a finger tip is not positioned on the front surface of the display section 20 at the time of the selection of an icon 21. Therefore, an arbitrary icon 21 can be accurately selected to perform a desired function, with its vie ability being ensured.

According to the present modification example, by pressing the tactile switches 34 with fingers after selecting an arbitrary icon 21, the user can obtain the actual feeling of switch operation. Therefore, a desired function associated with the selected icon can be unfailingly executed, whereby the operability of the input device 100 is improved.

(Electronic Device)

Next, an electronic device to which the input device and input operation method described in each of the above embodiments can be applied is described.

The input device 100 described in each of the above embodiments can be favorably applied in various electronic devices, such as a dedicated audio device, a wristwatch type communication terminal, and an exercise support terminal.

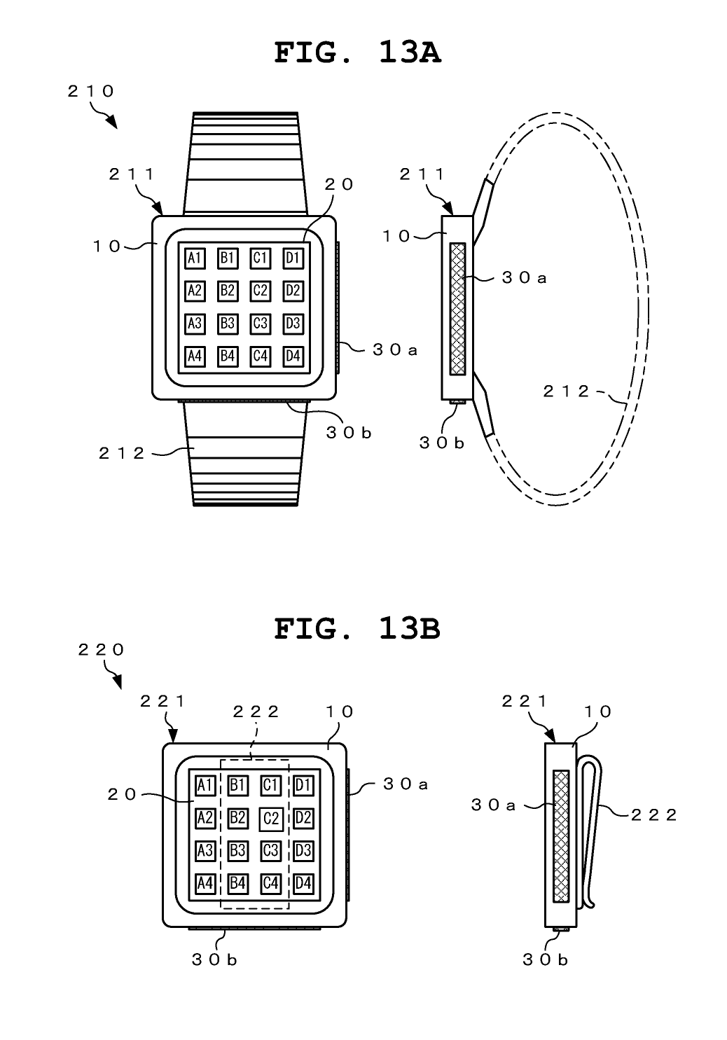

FIG. 13A and FIG. 13B are schematic structural diagrams showing examples of the electronic device in which the input device according to the present invention has been applied.

Note that components equivalent to those of each embodiment described above are provided with the same reference numerals and descriptions thereof are simplified.

In FIG. 13A, an electronic device 210 in which the present invention has been applied is a wristwatch type communication terminal or exercise support terminal that is used by being worn on a wrist (body) of the user, and mainly includes a device body 211 mounted with the input device 100 of the above-described embodiment and a belt section 212 for mounting the device body 211 on a wrist.

With the above-structured electronic device 210 being mounted on the body (for example, the left wrist) by the belt section 212, the user can operate the paired touch sensors 30aand 30b provided on outer circumferential side surfaces of the housing 10 with different fingers (for example, the index finger and the thumb of the right hand), and thereby selects an arbitrary icon 21 from among the plurality of icons 21 displayed on the display section 20 so as to perform a desired function.

In FIG. 13B, an electronic device 220 in which the present invention has been applied is a clip type dedicated audio device that is used by being mounted on a garment, belt, bag, or the like of the user, and mainly includes a device body 221 mounted with the input device 100 of the above-described embodiment and a clip section 222 for mounting the device body 221 on a garment, belt, or the like.

With the above-structured electronic device 220 being mounted on a garment, belt, or the like by the clip section 222 provided on the rear surface of the device body 221, the user can operate the paired touch sensors 30a and 30b provided on outer circumferential side surfaces of the housing 10 with his or her fingers, and thereby selects an arbitrary icon 21 from among the plurality of icons 21 displayed on the display section 20 so as to perform a desired function.

That is, by the input device 100 according to the present invention being applied in the electronic devices 210 and 220 as described above, a finger tip does not interfere with the user's view, unlike the case where the touch sensor on the front surface side of the display section 20 is directly touched by the finger tip to select an arbitrary icon (refer to FIG. 5A). Therefore, an arbitrary icon can be unfailingly selected to perform a desired function, with its viewability being ensured. As a result, the operability of the electronic devices 210 and 220 is improved.

In the input operation of the above-described embodiments an arbitrary icon 21 is selected from among the plurality of icons 21 arranged in matrix and displayed on the display area, and a predetermined function associated with the icon 21 is performed. However, the present invention is not limited thereto.

For example, in a case where the input device 100 according to the present invention is applied in a dedicated audio device or the like, a function may be achieved by the above-described input operation method, in which an icon for a piece of music is selected for playback and its sound level is adjusted during the playback by sliding a finger along the extending direction of the touch sensor 30a or 30b.

Also, a function may be achieved in which a plurality of image data or the like are stored in the data memory 13, their reduced images are displayed in the display area as icons 21, an arbitrary icon 21 is selected by the above-described input operation method, and the image of the icon 21 is displayed in the entire display area.

The input device 100 of the above-described embodiments is structured such that the touch sensors 30a and 30b for selecting an arbitrary icon 21 are exposed to outer circumferential side surfaces of the housing 10.

Thus, in the electronic device in which the input device 100 has been applied, there is a possibility of occurrence of an erroneous operation if any body part or a conductive member such as metal inadvertently comes in contact with the touch sensors 30a and 30b.

Also, in general, portable electronic devices are often lost or mislaid, and therefore there is a high possibility (risk) that an electronic device can be operated by others and personal information or the like stored in the electronic device will become leaked.

Accordingly, in order to prevent the occurrence of these problems, a configuration should preferably be adopted in which a lock function is started automatically or optionally by the user so that an input operation is prohibited after the lapse of a predetermined time from the end of the operation of the electronic device.

Here, as a method for starting the lock function by the user, a method may be applied in which the lock function is started on condition that an icon associated with the lock function is selected or an operation of releasing the lock function is registered within a specific time.

On the other hand, as a method for releasing the lock function, a method can be applied in which the lock is released by a specific operation being performed on the touch sensors 30a and 30b provided on the input device 100.

Specifically, methods can be applied in which, with a finger being in contact with the touch sensor 30a provided in the vertical direction or the touch sensor 30b provided in the horizontal direction, the user slides the finger in a specific direction or moves the finger back and forth.

Regarding the finger sliding method in this case, the speed, the number of times the sliding operation is paused, and the like may be finely set.

These releasing methods may be applied singly or in combination as appropriate. Here, a specific release time may be set and the lock may be released on condition that these releasing methods have been performed within the specific release time.

Also, in the structure where a touch panel is provided on the display section 20 or the structure where the tactile switches 34 are provided on outer circumferential side surfaces of the housing 10 described in the embodiments above, operations thereof may be combined to the above-described releasing method.

As such, the security function can be enhanced by making the releasing condition of the lock function complicated.

While the present invention has been described with reference to the preferred embodiments, it is intended that the invention be not limited by any of the details of the description therein but includes all the embodiments which fall within the scope of the appended claims.

1. An input device comprising:
a display section which has a display area where a plurality of icons are two-dimensionally arranged and displayed;
a first sensor section which has at least a pair of sensors provided spaced apart from each other in areas which do not overlap with the plurality of icons, and detects operated points operated by a first operation performed on the pair of sensors; and
an icon selecting section which selects one specific icon from among the plurality of icons displayed on the display area, based on the operated points detected by the first sensor section.

2. The input device according to claim 1, wherein
each of the pair of sensors of the first sensor is a touch sensor which detects a contact point of a human body touching the touch sensor,
wherein the first operation is an operation of bringing the human body into contact with each of the paired touch sensors, and
wherein the first sensor section detects, as the operated points, a first contact point detected by one of the touch sensors and a second contact point detected by other one of the touch sensors.

3. The input device according to claim 2, wherein
the icon selecting section causes a first cursor line to display at a point corresponding to the first contact point on the display area, causes a second cursor line to display at a point corresponding to the second contact point on the display area, and selects, as the specific icon, an icon at a point at intersection of the first cursor line and the second cursor line.

4. The input device according to claim 3, wherein
the icon selecting section causes a display position of the first cursor line to be changed according to a change of the first contact point, and causes a display position of the second cursor line to be changed according to a change of the second contact point.

5. The input device according to claim 2, wherein
the plurality of icons are arranged two-dimensionally in a first direction and a second direction,
the first sensor section has, as the pair of sensors, a first touch sensor provided extending along a third direction corresponding to the first direction, and a second touch sensor provided extending along a fourth direction corresponding to the second direction, and
wherein the first touch sensor and the second touch sensor are provided in an area where the first touch sensor and the second touch sensor do not overlap with each other.

6. The input device according to claim 5, wherein
the first sensor section has, as the touch sensors, a third touch sensor provided extending along a fifth direction corresponding to the first direction and positioned facing the first touch sensor across the display area, and a fourth touch sensor provided extending along a sixth direction corresponding to the second direction and positioned facing the second touch sensor across the display area,
wherein the first touch sensor, the second touch sensor, the third touch sensor, and the fourth touch sensor are provided in an area where the first touch sensor, the second touch sensor, the third touch sensor, and the fourth touch sensor do not overlap with each other, and
wherein one of the first touch sensor and the third touch sensor and one of the second touch sensor and the fourth touch sensor serve as the pair of sensors.

7. The input device according to claim 1, wherein
the plurality of icons are associated with different functions respectively, and
wherein the input device further comprises an icon function executing section which detects whether a predetermined second operation has been performed on the input device, and executes a specific function associated with the specific icon when the second operation is detected to have been performed.

8. The input device according to claim 7, wherein
the icon function executing section detects, as the second operation, a change of a contact state of a human body with respect to the input device.

9. The input device according to claim 8, wherein
each of the pair of sensors of the first sensor section is a touch sensor which detects a contact point of the human body touching the touch sensor, and
wherein the icon function executing section detects whether the second operation has been performed, by using at least one of the pair of sensors of the first sensor section.

10. The input device according to claim 7, wherein
the icon function executing section has a second sensor section which is different from the first sensor section and detects the second operation, and
wherein the second sensor section has a push?button?type operation switch integrally provided in at least one of the pair of sensors of the first sensor section.

11. The input device according to claim 7, wherein
the icon function executing section has a second sensor section which is different from the first sensor section and detects the second operation, and
wherein the second sensor section has a touch panel provided on a visual field side of the display area.

12. The input device according to claim 1, wherein
the pair of sensors of the first sensor section is provided extending along outer circumferential side surfaces of a housing surrounding the display section.

13. The input device according to claim 1, wherein
the display section has an outer circumferential area surrounding a perimeter of the display area, and
wherein the pair of sensors of the first sensor section is provided in the outer circumferential area of the display section.

14. The input device according to claim 1, wherein
the pair of sensors of the first sensor section is provided in areas outside the plurality of two-dimensionally arranged icons, in the display area of the display section.

15. An electronic device mounted with the input device according to claim 1.

16. An input operation method in an input device including a display section where a plurality of icons are displayed and a first sensor section having at least a pair of sensors provided spaced apart from each other in areas which do not overlap with the plurality of icons, comprising:
a step of two-dimensionally arranging and displaying the plurality of icons on a display area of the display section;
a step of causing the first sensor section to detect operated points operated by a first operation performed on the pair of sensors; and
a step of selecting one specific icon from among the plurality of icons displayed on the display area, based on the operated points detected by the first sensor section.

17. The input operation method according to claim 16, wherein
each of the pair of sensors of the first sensor section is a touch sensor which detects a contact point of a human body touching the touch sensor,
wherein the first operation is an operation of bringing the human body into contact with each of the paired touch sensors, and
wherein the step of detecting the operated points operated by the first operation includes a step of detecting, as the operated points, a first contact point on one of the touch sensors contacted by the human body and a second contact point on other one of the touch sensors contacted by the human body.

18. The input operation method according to claim 17, wherein
the step of selecting one specific icon includes:
a step of causing a first cursor line to display at a point corresponding to the first contact point on the display area,
a step of causing a display position of the first cursor line to be changed according to a change of the first contact point,
a step of causing a second cursor line to display at a point corresponding to the second contact point on the display area,
a step of causing a display position of the second cursor line to be changed according to a change of the second contact point, and
a step of selecting, as the specific icon, an icon at a point at intersection of the first cursor line and the second cursor line.

19. The input operation method according to claim 16, wherein
the plurality of icons are associated with different functions respectively, and
wherein the input operation method further comprises:
a step of detecting whether a predetermined second operation has been performed on the input device; and
a step of executing a specific function associated with the selected specific icon when the second operation is detected to have been performed.

20. A non-transitory computer-readable storage medium having stored thereon a control program for selecting one of a plurality of icons that is executable by a computer in an input device including a display section where a plurality of icons are displayed and a first sensor section having at least a pair of sensors provided spaced apart from each other in areas which do not overlap with the plurality of icons, wherein the program controls the input device to perform functions comprising:
processing for two-dimensionally arranging and displaying the plurality of icons on a display area of the display section;
processing for causing the first sensor section to detect operated points operated by a first operation performed on the pair of sensors; and
processing for selecting one specific icon from among the plurality of icons displayed on the display area, based on the operated points detected by the first sensor section.
